(19) United States
(12) Patent Application Publication
(10) Pub. No.: US 2013/0070222 A1
(43) Pub. Date: Mar. 21, 2013

(54) Method and System for Optimization of an Image on a Substrate to be Manufactured Using Optical Lithography

(71) Applicant: Akira Fujimura, Saratoga, CA (US)

(72) Inventor: Akira Fujimura, Saratoga, CA (US)

(73) Assignee: D2S, INC., San Jose, CA (US)

(21) Appl. No.: 13/236,610

(22) Filed: Sep. 19, 2011

(51) Int. Cl. G03B 27/42

(52) U.S. Cl. 355/53; 355/77

(57) ABSTRACT

A method and system for optimization of an image to be printed on a substrate using optical lithography is disclosed in which a set of charged particle beam shots, some of which overlap, is determined so as to form a target pattern on a surface such as a reticle. The charged particle beam shots are simulated to determine the pattern that would be formed on the surface. Next, a substrate image is calculated from the simulated surface pattern. One or more shots in the set of shots are then modified to improve the calculated substrate image.

### BACKGROUND OF THE DISCLOSURE

The present disclosure is related to lithography, and more particularly to the design and manufacture of a surface which may be a reticle, a wafer, or any other surface, using charged particle beam lithography.

In the production or manufacturing of semiconductor devices, such as integrated circuits, optical lithography may be used to fabricate the semiconductor devices. Optical lithography is a printing process in which a lithographic mask or photomask manufactured from a reticle is used to transfer patterns to a substrate such as a semiconductor or silicon wafer to create the integrated circuit (I.C.). Other substrates could include flat panel displays, holographic masks, or even other reticles. While conventional optical lithography uses a light source having a wavelength of 193 nm, extreme ultraviolet (EUV) or X-ray lithography are also considered types of optical lithography in this application. The reticle or multiple reticles may contain a circuit pattern corresponding to an individual layer of the integrated circuit, and this pattern can be imaged onto a certain area on the substrate that has been coated with a layer of radiation-sensitive material known as photoresist or resist. Once the patterned layer is transferred the layer may undergo various other processes such as etching, ion-implantation (doping), metallization, oxidation, and polishing. These processes are employed to finish an individual layer in the substrate. If several layers are required, then the whole process or variations thereof will be repeated for each new layer. Eventually, a combination of multiples of devices or integrated circuits will be present on the substrate. These integrated circuits may then be separated from one another by dicing or sawing and then may be mounted into individual packages. In the more general case, the patterns on the substrate may be used to define artifacts such as display pixels, holograms, or magnetic recording heads.

In the production or manufacturing of semiconductor devices, such as integrated circuits, non-optical methods may be used to transfer a pattern on a lithographic mask to a substrate such as a silicon wafer. Nanoimprint lithography (NIL) is an example of a non-optical lithography process. In nanoimprint lithography, a lithographic mask pattern is transferred to a surface through contact of the lithography mask with the surface.

Two common types of charged particle beam lithography are variable shaped beam (VSB) and character projection (CP). These are both sub-categories of shaped beam charged particle beam lithography, in which a precise electron beam is shaped and steered so as to expose a resist-coated surface, such as the surface of a wafer or the surface of a reticle. In VSB, these shapes are simple shapes, usually limited to rectangles of certain minimum and maximum sizes and with sides which are parallel to the axes of a Cartesian coordinate plane (i.e. of “manhattan” orientation), and 45 degree right triangles (i.e. triangles with their three internal angles being 45 degrees, 45 degrees, and 90 degrees) of certain minimum and maximum sizes. At predetermined locations, doses of electrons are shot into the resist with these simple shapes. The total writing time for this type of system increases with the number of shots. In character projection (CP), there is a stencil in the system that has in it a variety of apertures or characters which may be complex shapes such as rectilinear, arbitrary-angled linear, circular, nearly circular, annular, nearly annular, oval, nearly oval, partially circular, partially nearly circular, partially annular, partially nearly annular, partially nearly oval, or arbitrary curvilinear shapes, and which may be a connected set of complex shapes or a group of disjointed sets of a connected set of complex shapes. An electron beam can be shot through a character on the stencil to efficiently produce more complex patterns on the reticle. In theory, such a system can be faster than a VSB system because it can shoot more complex shapes with each time-consuming shot. Thus, an E-shaped pattern shot with a VSB system takes four shots, but the same E-shaped pattern can be shot with one shot with a character projection system. Note that VSB systems can be thought of as a special (simple) case of character projection, where the characters are just simple characters, usually rectangles or 45-45-90 degree triangles. It is also possible to partially expose a character. This can be done by, for instance, blocking part of the particle beam. For example, the E-shaped pattern described above can be partially exposed as an F-shaped pattern or an I-shaped pattern, where different parts of the beam are cut off by an aperture. This is the same mechanism as how various sized rectangles can be shot using VSB. In this disclosure, partial projection is used to mean both character projection and VSB projection.

As indicated, in lithography the lithographic mask or reticle comprises geometric patterns corresponding to the circuit components to be integrated onto a substrate. The patterns used to manufacture the reticle may be generated utilizing computer-aided design (CAD) software or programs. In designing the patterns the CAD program may follow a set of predetermined design rules in order to create the reticle. These rules are set by processing, design, and end-use limitations. An example of an end-use limitation is defining the geometry of a transistor in a way in which it cannot sufficiently operate at the required supply voltage. In particular, design rules can define the space tolerance between circuit devices or interconnect lines. The design rules are, for example, used to ensure that the circuit devices or lines do not interact with one another in an undesirable manner. For example, the design rules are used so that lines do not get too close to each other in a way that may cause a short circuit. The design rule limitations reflect, among other things, the smallest dimensions that can be reliably fabricated. When referring to these small dimensions, one usually introduces the concept of a critical dimension. These are, for instance, defined as the smallest width of a line or the smallest space between two lines, those dimensions requiring exquisite control.

One goal in integrated circuit fabrication by optical lithography is to reproduce the original circuit design on the substrate by use of the reticle. Integrated circuit fabricators are always attempting to use the semiconductor wafer real estate as efficiently as possible. Engineers keep shrinking the size of the circuits to allow the integrated circuits to contain more circuit elements and to use less power. As the size of an integrated circuit critical dimension is reduced and its circuit density increases, the critical dimension of the circuit pattern or physical design approaches the resolution limit of the optical exposure tool used in conventional optical lithography. As the critical dimensions of the circuit pattern become smaller and approach the resolution value of the exposure tool, the accurate transcription of the physical design to the actual circuit pattern developed on the resist layer becomes difficult. To further the use of optical lithography to transfer patterns having features that are smaller than the light wavelength used in the optical lithography process, a process known as optical proximity correction (OPC) has been developed. OPC alters the physical design to compensate for distortions caused by effects such as optical diffraction and the optical interaction of features with proximate features. OPC includes all resolution enhancement technologies performed with a reticle.

OPC may add sub-resolution lithographic features to mask patterns to reduce differences between the original physical design pattern, that is, the design, and the final transferred circuit pattern on the substrate. The sub-resolution lithographic features interact with the original patterns in the physical design and with each other and compensate for proximity effects to improve the final transferred circuit pattern. One feature that is used to improve the transfer of the pattern is a sub-resolution assist feature (SRAF). Another feature that is added to improve pattern transference is referred to as “serifs.” Serifs are small features that can be positioned on an interior or exterior corner of a pattern to sharpen the corner in the final transferred image. It is often the case that the precision demanded of the surface manufacturing process for SRAFs is less than the precision demanded for patterns that are intended to print on the substrate, often referred to as main features. Serifs are a part of a main feature. As the limits of optical lithography are being extended far into the sub-wavelength regime, the OPC features must be made more and more complex in order to compensate for even more subtle interactions and effects. As imaging systems are pushed closer to their limits, the ability to produce reticles with sufficiently fine OPC features becomes critical. Although adding serifs or other OPC features to a mask pattern is advantageous, it also substantially increases the total feature count in the mask pattern. For example, adding a serif to each of the corners of a square using conventional techniques adds eight more rectangles to a mask or reticle pattern. Adding OPC features is a very laborious task, requires costly computation time, and results in more expensive reticles. Not only are OPC patterns complex, but since optical proximity effects are long range compared to minimum line and space dimensions, the correct OPC patterns in a given location depend significantly on what other geometry is in the neighborhood. Thus, for instance, a line end will have different size serifs depending on what is near it on the reticle. This is even though the objective might be to produce exactly the same shape on the wafer. These slight but critical variations are important and have prevented others from being able to form reticle patterns. It is conventional to discuss the OPC-decorated patterns to be written on a reticle in terms of main features, that is features that reflect the design before OPC decoration, and OPC features, where OPC features might include serifs, jogs, and SRAF. To quantify what is meant by slight variations, a typical slight variation in OPC decoration from neighborhood to neighborhood might be 5% to 80% of a main feature size. Note that for clarity, variations in the design of the OPC are what is being referenced. Manufacturing variations such as corner rounding will also be present in the actual surface patterns. When these OPC variations produce substantially the same patterns on the wafer, what is meant is that the geometry on the wafer is targeted to be the same within a specified error, which depends on the details of the function that that geometry is designed to perform, e.g., a transistor or a wire. Nevertheless, typical specifications are in the 2%-50% of a main feature range. There are numerous manufacturing factors that also cause variations, but the OPC component of that overall error is often in the range listed. OPC shapes such as sub-resolution assist features are subject to various design rules, such as a rule based on the size of the smallest feature that can be transferred to the wafer using optical lithography. Other design rules may come from the mask manufacturing process or, if a character projection charged particle beam writing system is used to form the pattern on a reticle, from the stencil manufacturing process. It should also be noted that the accuracy requirement of the SRAF features on the mask may be lower than the accuracy requirements for the main features on the mask. As process nodes continue to shrink, the size of the smallest SRAFs on a photomask also shrinks. For example, at the 20 nm logic process node, 40 nm to 60 nm SRAFs are needed on the mask for the highest precision layers.

Inverse lithography technology (ILT) is one type of OPC technique. ILT is a process in which a pattern to be formed on a reticle is directly computed from a pattern which is desired to be formed on a substrate such as a silicon wafer. This may include simulating the optical lithography process in the reverse direction, using the desired pattern on the substrate as input. ILT-computed reticle patterns may be purely curvilinear—i.e. completely non-rectilinear—and may include circular, nearly circular, annular, nearly annular, oval and/or nearly oval patterns. Since these ideal ILT curvilinear patterns are difficult and expensive to form on a reticle using conventional techniques, rectilinear approximations or rectilinearizations of the curvilinear patterns may be used. The rectilinear approximations decrease accuracy, however, compared to the ideal ILT curvilinear patterns. Additionally, if the rectilinear approximations are produced from the ideal ILT curvilinear patterns, the overall calculation time is increased compared to ideal ILT curvilinear patterns. In this disclosure ILT, OPC, source mask optimization (SMO), and computational lithography are terms that are used interchangeably.

There are a number of technologies used for forming patterns on a reticle, including using optical lithography or charged particle beam lithography. The most commonly used system is the variable shaped beam (VSB), where, as described above, doses of electrons with simple shapes such as manhattan rectangles and 45-degree right triangles expose a resist-coated reticle surface. In conventional mask writing, the doses or shots of electrons are conventionally designed to avoid overlap wherever possible, so as to greatly simplify calculation of how the resist on the reticle will register the pattern. Similarly, the set of shots is designed so as to completely cover the pattern area that is to be formed on the reticle. U.S. Pat. No. 7,754,401, owned by the assignee of the present patent application and incorporated by reference for all purposes, discloses a method of mask writing in which intentional shot overlap for writing patterns is used. When overlapping shots are used, charged particle beam simulation can be used to determine the pattern that the resist on the reticle will register. Use of overlapping shots may allow patterns to be written with reduced shot count or higher accuracy or both. U.S. Pat. No. 7,754,401 also discloses use of dose modulation, where the assigned dosages of shots vary with respect to the dosages of other shots. The term model-based fracturing is used to describe the process of determining shots using the techniques of U.S. Pat. No. 7,754,401.

Reticle writing for the most advanced technology nodes typically involves multiple passes of charged particle beam writing, a process called multi-pass exposure, whereby the given shape on the reticle is written and overwritten. Typically, two to four passes are used to write a reticle to average out precision errors in the charged particle beam writer, allowing the creation of more accurate photomasks. Also typically, the list of shots, including the dosages, is the same for every pass. In one variation of multi-pass exposure, the lists of shots may vary among exposure passes, but the union of the shots in any exposure pass covers the same area. Multi-pass writing can reduce over-heating of the resist coating the surface. Multi-pass writing also averages out random errors of the charged particle beam writer.

Current optical lithography writing machines typically reduce the photomask pattern by a factor of four during the optical lithographic process. Therefore, patterns formed on a reticle or mask must be four times larger than the size of the desired pattern on the substrate or wafer.

### SUMMARY OF THE DISCLOSURE

A method and system for optimization of an image to be printed on a substrate using optical lithography is disclosed in which a set of charged particle beam shots, some of which overlap, is determined so as to form a target pattern on a surface such as a reticle. The charged particle beam shots are simulated to determine the pattern that would be formed on the surface. Next, a substrate image is calculated from the simulated surface pattern. One or more shots in the set of shots are then modified to improve the calculated substrate image.

### BRIEF DESCRIPTION OF THE DRAWINGS

FIG. 1 illustrates an example of a charged particle beam system;

FIG. 2A illustrates an example of a designed pattern from a computer-aided design (CAD) system;

FIG. 2B illustrates an example of an image that is desired to be formed on a wafer from the CAD pattern of FIG. 2A;

FIG. 2C illustrates an example of an OPC-calculated pattern for a reticle, which is intended to form the pattern of FIG. 2B on the wafer;

FIG. 2D illustrates an example of a rectilinearized version of the pattern of FIG. 2C;

FIG. 3A illustrates an example of a set of shots;

FIG. 3B illustrates an example of a calculated reticle pattern that may be formed from the set of shots of FIG. 3A;

FIG. 3C illustrates an example of a wafer image calculated from the reticle pattern of FIG. 3B;

FIG. 4A illustrates an example of a set of shots, modified from the set of shots of FIG. 3A;

FIG. 4B illustrates an example of a calculated reticle pattern that may be formed from the set of shots of FIG. 4A;

FIG. 4C illustrates an example of a wafer image calculated from the reticle pattern of FIG. 4B;

FIG. 5 illustrates an embodiment of a conceptual flow diagram for performing double simulation;

FIG. 6 illustrates an embodiment of a conceptual flow diagram for preparing a surface in fabricating a substrate such as an integrated circuit on a silicon wafer;

FIG. 7A illustrates an example of a cross-sectional dosage graph, showing registered pattern widths for each of two resist thresholds; and

FIG. 7B illustrates an example of a cross-sectional dosage graph similar to FIG. 7A, but with a higher dosage edge slope than in FIG. 7A.

### DETAILED DESCRIPTION OF THE EMBODIMENTS

The improvements and advantages of the present disclosure can be accomplished using double simulation to determine an image that will be formed on a substrate such as a silicon wafer using an optical lithographic process, and then modifying the set of shots so as to improve or optimize the simulated substrate image.

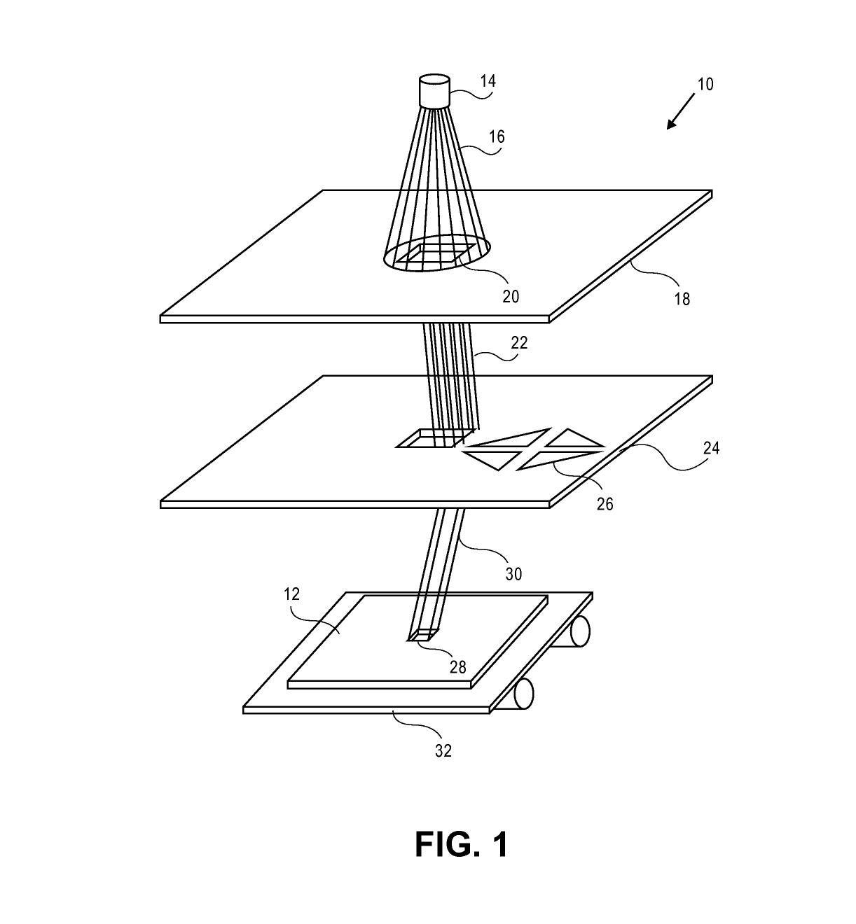

Referring now to the drawings, wherein like numbers refer to like items, FIG. 1 identifies an embodiment of a lithography system, such as a charged particle beam writer system, in this case an electron beam writer system 10, that employs a variable shaped beam (VSB) to manufacture a surface 12 according to the present disclosure. The electron beam writer system 10 has an electron beam source 14 that projects an electron beam 16 toward an aperture plate 18. The plate 18 has an aperture 20 formed therein which allows the electron beam 16 to pass. Once the electron beam 16 passes through the aperture 20 it is directed or deflected by a system of lenses (not shown) as electron beam 22 toward another rectangular aperture plate or stencil mask 24. The stencil mask 24 has formed therein a number of apertures 26 that define various simple shapes such as rectangles and triangles. Each aperture 26 formed in the stencil mask 24 may be used to form a pattern on the surface 12. An electron beam 30 emerges from one of the apertures 26 and is directed onto the surface 12 as a pattern 28. The surface 12 is coated with resist (not shown) which reacts with the electron beam 30. The electron beam 22 may be directed to overlap a variable portion of an aperture 26, affecting the size and shape of the pattern 28. The surface 12 is mounted on a movable platform 32. The platform 32 allows surface 12 to be repositioned so that patterns which are larger than the maximum deflection capability or field size of the charged particle beam 30 may be written to surface 12. In one embodiment the surface 12 may be a reticle. In this embodiment, the reticle, after being exposed with the pattern, undergoes various manufacturing steps through which it becomes a lithographic mask or photomask. The mask may then be used in an optical lithography machine to project an image of the reticle pattern 28, generally reduced in size, onto a silicon wafer to produce an integrated circuit. More generally, the mask is used in another device or machine to transfer the pattern 28 on to a substrate. In another embodiment the surface 12 may be the surface of a substrate such as a silicon wafer.

The minimum size pattern that can be projected with reasonable accuracy onto a surface 12 is limited by a variety of short-range physical effects associated with the electron beam writer system 10 and with the surface 12. These effects include forward scattering, Coulomb effect, and resist diffusion. Beam blur, also called β_{f}, is a term used to include all of these short-range effects. The most modern electron beam writer systems can achieve an effective beam blur radius or β_{f} in the range of 20 nm to 30 nm. Forward scattering may constitute one quarter to one half of the total beam blur. Modern electron beam writer systems contain numerous mechanisms to reduce each of the constituent pieces of beam blur to a minimum. Since some components of beam blur are a function of the calibration level of a particle beam writer, the β_{f} of two particle beam writers of the same design may differ. The diffusion characteristics of resists may also vary. Variation of β_{f} based on shot size or shot dose can be simulated and systemically accounted for. But there are other effects that cannot or are not accounted for, and they appear as random variation.

The shot dosage of a charged particle beam writer such as an electron beam writer system is a function of the intensity of the beam source 14 and the exposure time for each shot. Typically the beam intensity remains fixed, and the exposure time is varied to obtain variable shot dosages. The exposure time may be varied to compensate for various long-range effects such as back scatter and fogging in a process called proximity effect correction (PEC). Electron beam writer systems usually allow setting an overall dosage, called a base dosage, which affects all shots in an exposure pass. Some electron beam writer systems perform dosage compensation calculations within the electron beam writer system itself, and do not allow the dosage of each shot to be assigned individually as part of the input shot list, the input shots therefore having unassigned shot dosages. In such electron beam writer systems all shots have the base dosage, before PEC. Other electron beam writer systems do allow dosage assignment on a shot-by-shot basis. In electron beam writer systems that allow shot-by-shot dosage assignment, the number of available dosage levels may be 64 to 4096 or more, or there may be a relatively few available dosage levels, such as 3 to 8 levels. Some embodiments of the current invention are targeted for use with charged particle beam writing systems which allow assignment of one of a relatively few dosage levels.

The mechanisms within electron beam writers have a relatively coarse resolution for calculations. As such, mid-range corrections such as may be required for EUV masks in the range of 2 μm cannot be computed accurately by current electron beam writers.

Conventionally, shots are designed so as to completely cover an input pattern with rectangular shots, while avoiding shot overlap wherever possible. Also, all shots are designed to have a normal dosage, which is a dosage at which a relatively large rectangular shot, in the absence of long-range effects, will produce a pattern on the surface which is the same size as is the shot size.

In exposing, for example, a repeated pattern on a surface using charged particle beam lithography, the size of each pattern instance, as measured on the final manufactured surface, will be slightly different, due to manufacturing variations. The amount of the size variation is an essential manufacturing optimization criterion. In current mask masking, a root mean square (RMS) variation of no more than 1 nm (1 sigma) in pattern size may be desired. More size variation translates to more variation in circuit performance, leading to higher design margins being required, making it increasingly difficult to design faster, lower-power integrated circuits. This variation is referred to as critical dimension (CD) variation. A low CD variation is desirable, and indicates that manufacturing variations will produce relatively small size variations on the final manufactured surface. In the smaller scale, the effects of a high CD variation may be observed as line edge roughness (LER). LER is caused by each part of a line edge being slightly differently manufactured, leading to some waviness in a line that is intended to have a straight edge. CD variation is, among other things, inversely related to the slope of the dosage curve at the resist threshold, which is called edge slope. Therefore, edge slope, or dose margin, is a critical optimization factor for particle beam writing of surfaces. In this disclosure, edge slope and dose margin are terms that are used interchangeably.

With conventional fracturing, without shot overlap, gaps or dose modulation, the dose margin of the written shapes is considered immutable: that is, there is no opportunity to improve dose margin by a choice of fracturing options. In modern practice, the avoidance of very narrow shots called slivers is an example of a practical rule-based method that helps to optimize the shot list for dose margin.

In a fracturing environment where overlapping shots and dose-modulated shots can be generated, there is both a need and an opportunity to optimize for dose margin. The additional flexibility in shot combinations allowed by use of shot overlap and dose modulation allows generation of fracturing solutions that appear to generate the target mask shapes on the surface, but may do so only under perfect manufacturing conditions. The use of overlapping shots and dose-modulated shots therefore creates incentive to address the issue of dose margin and its improvement.

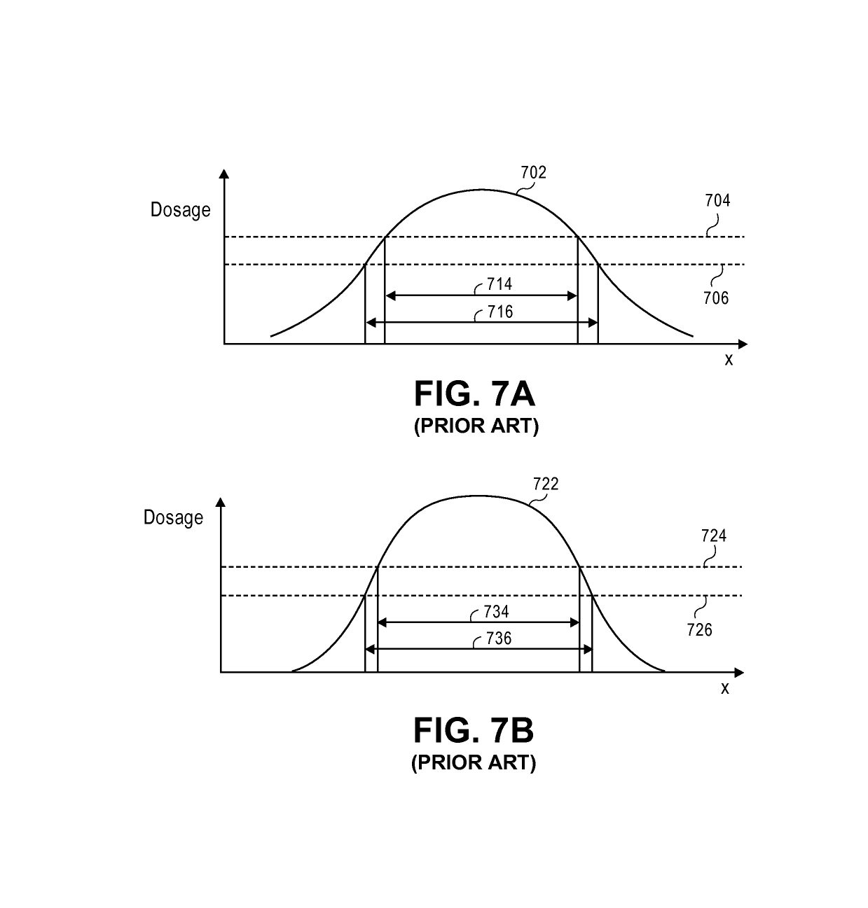

FIGS. 7A-B illustrate how critical dimension variation can be reduced by exposing the pattern on the resist so as to produce a relatively high edge slope in the exposure or dosage curve, such as is described in U.S. patent application Ser. No. 13/168,954 filed Jun. 25, 2011, entitled “Method and System for Forming High Accuracy Patterns Using Charged Particle Beam Lithography,” which is hereby incorporated by reference for all purposes. FIG. 7A illustrates a cross-sectional dosage curve 702, where the x-axis shows the cross-sectional distance through an exposed pattern—such as the distance perpendicular to two of the pattern's edges—and the y-axis shows the dosage received by the resist. A pattern is registered by the resist where the received dosage is higher than a threshold. Two thresholds are illustrated in FIG. 7A, illustrating the effect of a variation in resist sensitivity. The higher threshold 704 causes a pattern of width 714 to be registered by the resist. The lower threshold 706 causes a pattern of width 716 to be registered by the resist, where width 716 is greater than width 714. FIG. 7B illustrates another cross-sectional dosage curve 722. Two thresholds are illustrated, where threshold 724 is the same as threshold 704 of FIG. 7A, and threshold 726 is the same as threshold 706 of FIG. 7A. The slope of dosage curve 722 is higher in the vicinity of the two thresholds than is the slope of dosage curve 702. For dosage curve 722, the higher threshold 724 causes a pattern of width 734 to be registered by the resist. The lower threshold 726 causes a pattern of width 736 to be registered by the resist. As can be seen, the difference between width 736 and width 734 is less than the difference between width 716 and width 714, due to the higher edge slope of dosage curve 722 compared to dosage curve 702. If the resist-coated surface is a reticle, then the lower sensitivity of curve 722 to variation in resist threshold can cause the pattern width on a photomask manufactured from the reticle to be closer to the target pattern width for the photomask, thereby increasing the yield of usable integrated circuits when the photomask is used to transfer a pattern to a substrate such as a silicon wafer. Similar improvement in tolerance to variation in dose for each shot is observed for dose curves with higher edge slopes. Achieving a relatively higher edge slope such as in dosage curve 722 is therefore desirable.

As described above, process variations can cause the width of a pattern on a photomask to vary from the intended or target width. The pattern width variation on the photomask will cause a pattern width variation on a wafer which has been exposed using the photomask in an optical lithographic process. The sensitivity of the wafer pattern width to variations in photomask pattern width is called mask edge error factor, or MEEF. In an optical lithography system using a 4× photomask, where the optical lithographic process projects a 4× reduced version of the photomask pattern onto the wafer, a MEEF of 1, for example means that for each 1 nm error in pattern width on a photomask, the pattern width on the wafer will change by 0.25 nm. A MEEF of 2 means that for a 1 nm error in photomask pattern width, the pattern width on the wafer will change by 0.5 nm. For the smallest integrated circuits processes, MEEF may be greater than 2.

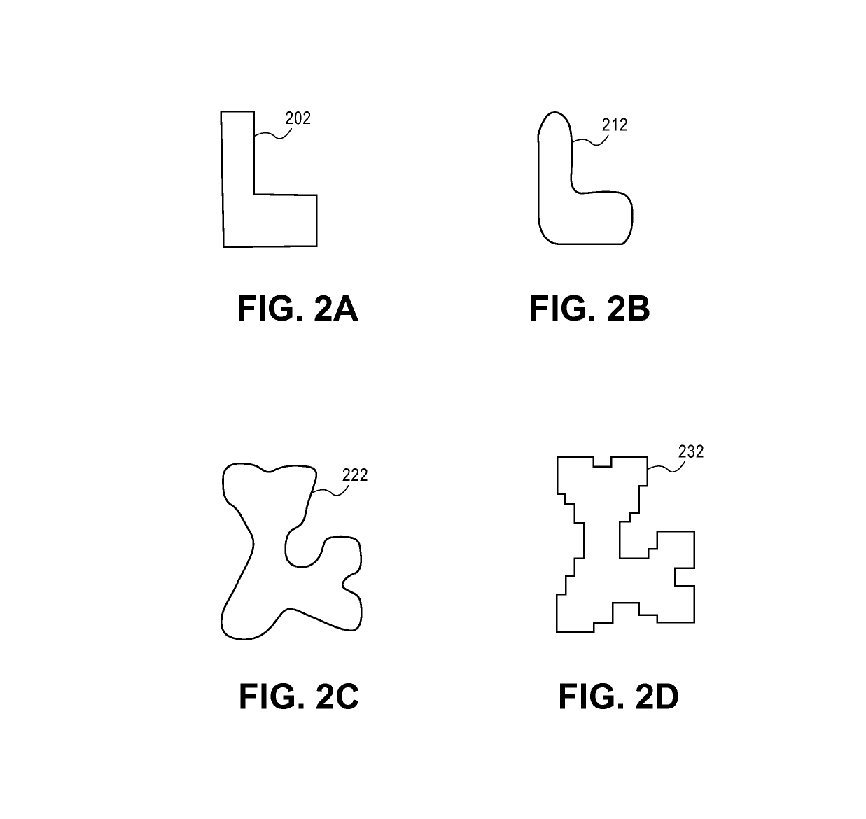

FIG. 2A illustrates an example of a computer-aided design (CAD) pattern 202, that is a pattern that was output from a CAD system. As can be seen, all edges of CAD pattern 202 are manhattan, and all corners are square. Although patterns output from a CAD system commonly have square corners, it is well-known that square corners, for example, cannot be formed on a wafer using conventional optical lithographic technology. FIG. 2B illustrates an example of a pattern 212 which is a target image for the wafer, based on the CAD pattern 202. Target wafer image 212 is the curvilinear image that is realistically desired to be formed on the wafer. FIG. 2C illustrates an example of a target pattern 222 for a reticle that, if used in an optical lithographic process, can form an image similar to image 212 on a wafer. The pattern 222 may be, in general, the output of an OPC process. In some embodiments, pattern 222 may be the output of an ILT process which creates ideal curvilinear shapes for the reticle patterns. It is, however, difficult to generate a set of conventional non-overlapping VSB shots which will form a curvilinear pattern such as pattern 222 on a reticle. Therefore, an ILT post-processing step may be done to rectilinearize the pattern 222, which is to say create a rectilinear pattern, such as the FIG. 2D pattern 232, which can form a wafer image that is close to the target wafer image 212. Rectilinearized ILT patterns are more easily fractured using conventional non-overlapping shots than are ideal curvilinear ILT patterns. As described above, rectilinearization has two disadvantages, however: 1) rectilinearlization is a compute-intensive process and is therefore slow, and 2) the image that can be formed on the wafer using a rectilinearized pattern such as pattern 232 may not be as close to the target wafer image 212 as if a reticle with the ideal pattern 222 had been used. Related to 2), a reticle made with the rectilinearized pattern may have poorer manufacturability than a reticle made using the ideal curvilinear ILT pattern.

Use of model-based fracturing allows generation of a set of shots that can form a pattern such as the curvilinear pattern 222 with higher accuracy and/or with fewer shots than using conventional non-overlapping VSB shots. In model-based fracturing, shots may overlap, and if assigned shot dosages are supported by the particle beam exposure system, different shots may have different dosages before correction for long range effects, called proximity effect correction or PEC. When used with ILT, model-based fracturing of ideal curvilinear ILT patterns such as pattern 222 may be done, obviating the need for rectilinearization. Model-based fracturing may be used either with VSB or with complex character projection (CP).

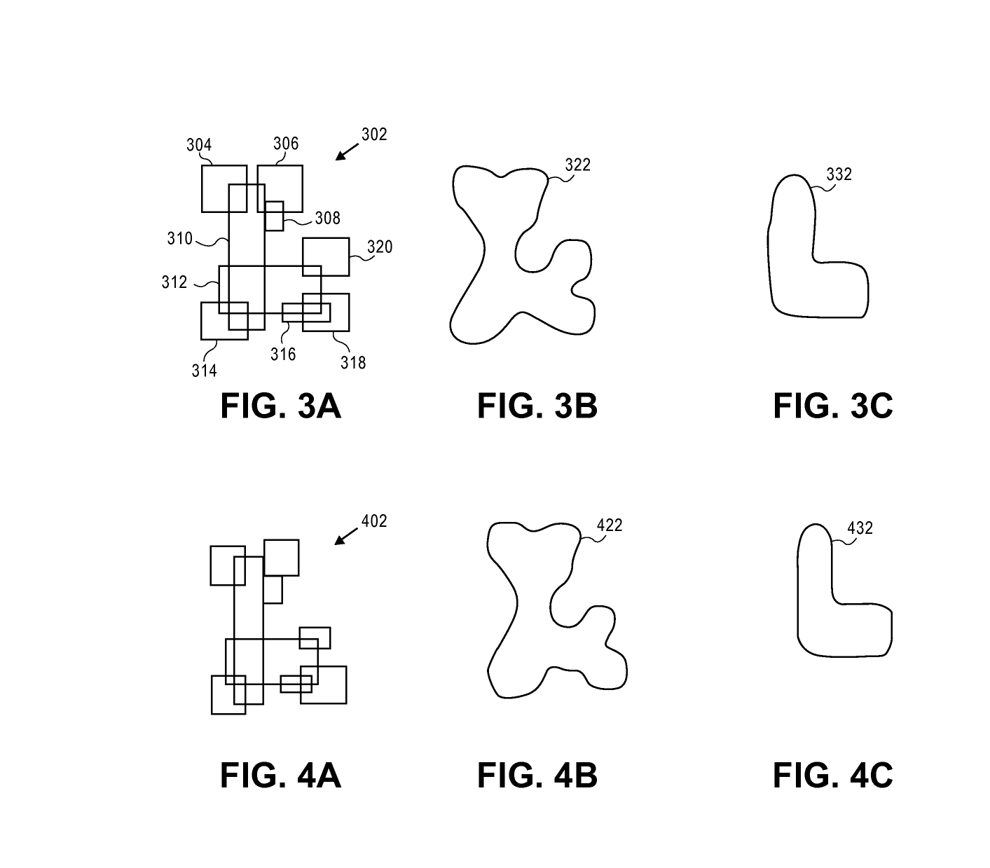

FIG. 3A illustrates an example of a set of overlapping shots 302 that may be generated to form the pattern 222 of FIG. 2C. Set of shots 302 consists of nine VSB shots: shot 304, shot 306, shot 308, shot 310, shot 312, shot 314, shot 316, shot 318, and shot 320. FIG. 3B illustrates an example of a pattern 322 that can be produced on a reticle using the set of shots 302. Reticle pattern 322 may be simulated, so as to determine its shape before manufacturing the reticle and photomask. Simulation of the effects contributing to formation of reticle pattern 322 from set of shots 302 requires consideration of many effects, which may be organized into two groups:

Phenomena which are associated with the particle beam exposure itself. Effects that may be simulated include forward scattering, backward scattering, resist diffusion, Coulomb effect, fogging, loading and resist charging. Simulation of these effects is called charged particle beam simulation.

Phenomena that follow the particle beam exposure process. These include the resist baking process, the resist development process, and the etch process. Simulation of these effects is called mask process simulation. The simplest form is a constant or a rule-based bias model which is contemplated in this disclosure.

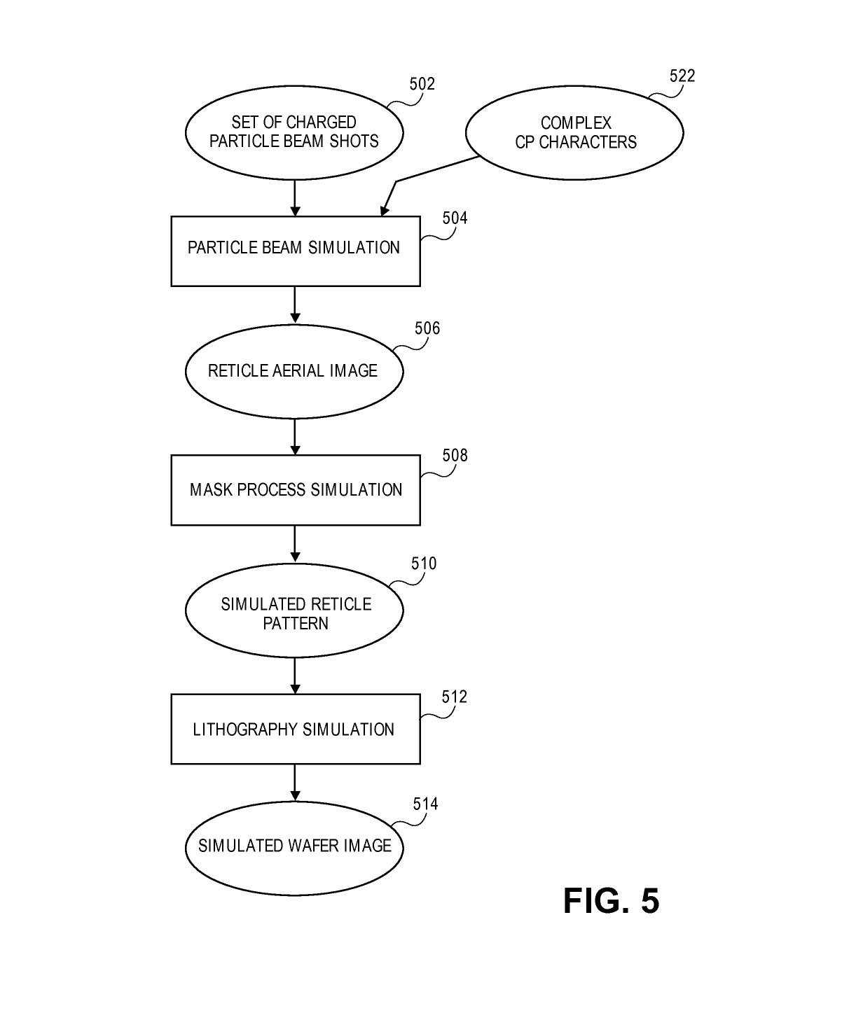

In some embodiments of the present invention, simulation of the reticle pattern is followed by calculation of a wafer image using the simulated reticle pattern. The reticle pattern simulation and wafer image calculation steps together are called double simulation in this disclosure. The conceptual flow diagram FIG. 5 illustrates double simulation. The input to the process is a set of charged particle beam shots 502, such as set of shots 302. In one embodiment, where some shots in the set of shots 502 are complex character shots, a library of complex CP characters 522 is also input. In step 504 charged particle beam simulation is performed. Effects that may be simulated include forward scattering, backward scattering, resist diffusion, Coulomb effect, fogging, loading and resist charging. The output of charged particle beam simulation is a reticle aerial image 506. In step 508, mask process simulation simulates the effect of various post-exposure processes to create a simulated reticle pattern 510. Mask process simulation may include simulation of resist baking, resist development and etch. Charged particle beam simulation 504 and mask process simulation 508 may be bundled together into a single step, or in other embodiments may be separate steps. In step 512 lithography simulation calculates the image 514 that will be formed on a substrate such as a wafer using the simulated reticle pattern 510.

Referring to FIGS. 3A-C, charged particle beam simulation and mask process simulation may be used to calculate a reticle pattern 322 that will be formed from set of shots 302. Reticle pattern 322 may then be used as input to lithography simulation to calculate a wafer image 332 of FIG. 3C. Simulated wafer image 332 may be compared with target wafer image 212. In one embodiment, the present invention comprises comparing the simulated wafer image 332 with target wafer image 212, and then modifying shots in group of shots 302, such as with an optimization process, so as to reduce the difference between the simulated wafer image 332 and the target wafer image 212.

FIG. 4A illustrates an example of a set of shots 402 that may result from modifying the set of shots 302. Like set of shots 302, set of shots 402 contains nine shots, but many of the shots in set of shots 402 have different positions and/or sizes compared to the corresponding shots in set of shots 302. FIG. 4B illustrates an example of a simulated reticle pattern 422 that may result from set of shots 402. Charged particle beam simulation and mask process simulation may be used to calculate pattern 422 from set of shots 402. FIG. 4C illustrates a calculated wafer image 432 which can be determined from reticle pattern 422 through the use of lithography simulation. Simulated wafer image 432 is closer to the target wafer image 212 than is simulated wafer image 332.

In another embodiment of the current invention, shot modification such as is illustrated in set of shots 402 may be done so as to improve any of a variety of wafer manufacturability characteristics associated with a patterned reticle, such as a reticle containing the pattern 422. These manufacturability characteristics include process variation (PV) band, depth of field, mask edge error factor (MEEF), CD variation, and area variation. Manufacturability improvement can allow the pattern produced on the wafer to be closer to the target wafer image 212 through a wider range of process variations than if the unmodified set of shots 302 had been used. Manufacturability improvement may, for example, increase the yield of good wafers in the face of manufacturing process variations. Optimization techniques may be used to determine the shot modifications.

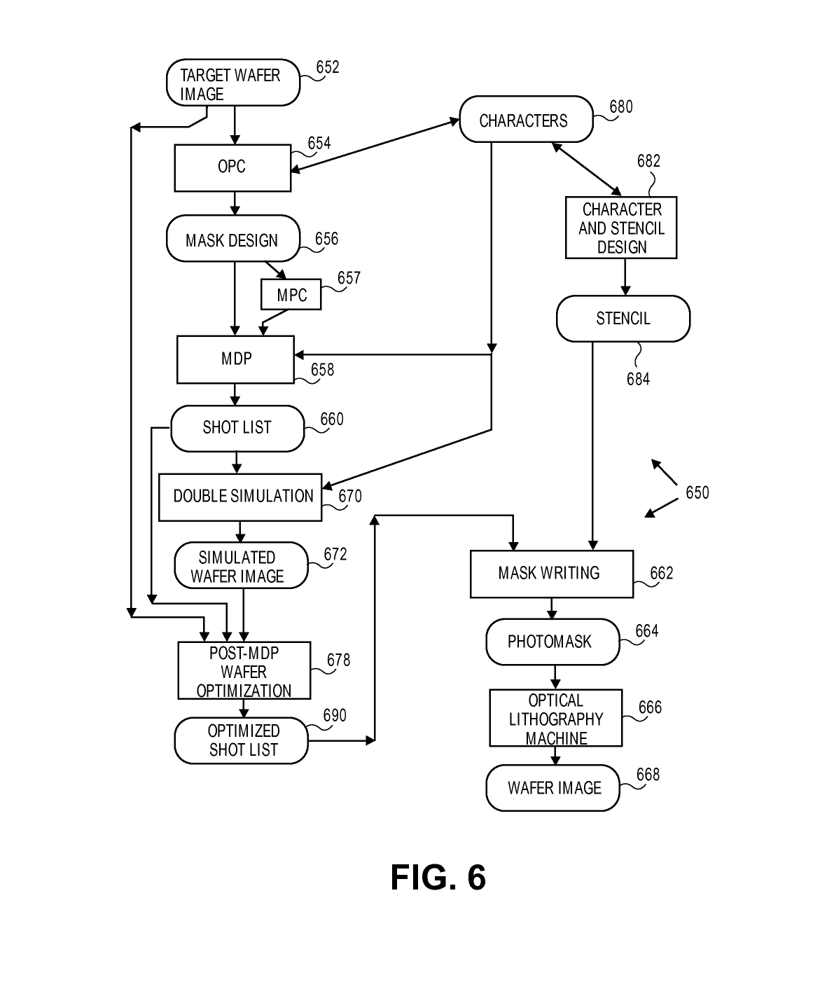

FIG. 6 is a conceptual flow diagram 650 of how to prepare a reticle for use in fabricating a surface such as an integrated circuit on a silicon wafer, using double simulation with shot optimization. The input to the flow is a target wafer image 652, obtained from a CAD pattern such as a physical design of an integrated circuit. Next, in a step 654, optical proximity correction (OPC) is determined. In an embodiment of this disclosure, step 654 can include taking as input a library of pre-designed characters 680 including complex characters that are to be available on a stencil 684 in a step 662. Stencil 684 may be pre-designed for use by multiple designs, and the use of characters 680 is optimized by OPC 654 and/or MDP 658. In an embodiment of this disclosure, an OPC step 654 may also include simultaneous optimization of shot count or write times, and may also include a fracturing operation, a shot placement operation, a dose assignment operation, or may also include a shot sequence optimization operation, or other mask data preparation operations, with some or all of these operations being simultaneous or combined in a single step. The OPC step 654 may create partially or completely curvilinear patterns. In an embodiment of this disclosure, the OPC step 654 may comprise ILT which creates ideal curvilinear ILT patterns. The output of the OPC step 654 is a mask design 656.

Mask process correction (MPC) 657 may optionally be performed on the mask design 656. MPC modifies the pattern to be written to the reticle so as to compensate for non-linear effects, such as effects associated with patterns smaller than about 100 nm in conventional masks for use with optical lithography. MPC may also be used to compensate for non-linear effects affecting EUV masks. If MPC 657 is performed, its output becomes the input for mask data preparation (MDP) step 658.

In a step 658, a mask data preparation (MDP) operation, which may include a fracturing operation, a shot placement operation, a dose assignment operation, or a shot sequence optimization, may take place. MDP may use as input the mask design 656 or the results of MPC 657. In some embodiments of the present invention, MPC may be performed as part of a fracturing or other MDP operation. Other corrections may also be performed as part of fracturing or other MDP operation, the possible corrections including: forward scattering, resist diffusion, Coulomb effect, etching, backward scattering, fogging, loading, resist charging, and EUV midrange scattering. The result of MDP step 658 is a shot list 660. Combining OPC and any or all of the various operations of mask data preparation in one step is contemplated in this disclosure. Mask data preparation may also comprise inputting patterns to be formed on a reticle with the patterns being slightly different, selecting a set of characters to be used to form the number of patterns, the set of characters fitting on a stencil mask, the set of characters possibly including both complex and VSB characters, and the set of characters based on varying character dose or varying character position or varying the beam blur radius or applying partial exposure of a character within the set of characters or dragging a character to reduce the shot count or total write time. A set of slightly different patterns on the reticle may be designed to produce substantially the same pattern on a substrate. Also, the set of characters may be selected from a predetermined set of characters. In one embodiment of this disclosure, a set of characters available on a stencil in a step 680 that may be selected quickly during the mask writing step 662 may be prepared for a specific mask design. In that embodiment, once the mask data preparation step 658 is completed, a stencil is prepared in a step 684. In another embodiment of this disclosure, a stencil is prepared in the step 684 prior to or simultaneous with the MDP step 658 and may be independent of the particular mask design. In this embodiment, the characters available in the step 680 and the stencil layout are designed in step 682 to output generically for many potential mask designs 656 to incorporate patterns that are likely to be output by a particular OPC program 654 or a particular MDP program 658 or particular types of designs that characterizes types of physical designs, such as memories, flash memories, system on chip designs, or particular process technology, or a particular cell library used to create the physical design, or any other common characteristics that may form different sets of slightly different patterns in mask design 656. The stencil can include a set of characters, such as a limited number of characters that was determined in the step 658. In yet another embodiment of this disclosure, only VSB shots are used without complex characters.

The shot list 660 is used as input to double simulation 670, as set forth in FIG. 5 and described above, to create a simulated wafer image 672. Additionally, a set of complex characters 680 may be input to double simulation 670 if the shot list 660 includes complex character shots. Using simulated wafer image 672, target wafer image 652, and shot list 660, post-MDP wafer optimization is done in step 678. In this optimization step, shots in shot list 660 are modified to improve the wafer image. This improvement may comprise reducing the difference between the simulated wafer image 672 and the target wafer image 652, and/or may also comprise improving manufacturability of the wafer by improving, for example, any of process variation (PV) band, depth of field, MEEF, CD variation and area variation. Post-MDP wafer optimization 678 may also comprise doing double simulation, for example, to determine if the modified shots will produce a simulated wafer image that is sufficiently close to the target wafer image 652. Post-MDP wafer optimization 678 produces an optimized shot list 690.

The optimized shot list 690 is used to generate a reticle in a mask writing step 662, which uses a charged particle beam writer such as an electron beam writer system. Mask writing step 662 may use stencil 684 containing both VSB apertures and a plurality of complex characters, or may use a stencil comprising only VSB apertures. The electron beam writer system projects a beam of electrons through the stencil onto a surface to form patterns on a surface such as a reticle, which is then processed to become a photomask 664. The completed photomask 664 may then be used in an optical lithography machine, which is shown in a step 666. Finally, in a step 668, a substrate such as a silicon wafer is produced. As has been previously described, in step 680 characters may be provided to the OPC step 654, the MDP step 658, and/or the double simulation step 670. The step 680 also provides characters to a character and stencil design step 682. The character and stencil design step 682 provides input to the stencil step 684 and to the characters step 680.

The OPC, fracturing, mask data preparation, proximity effect correction and wafer optimization flows described in this disclosure may be implemented using general-purpose computers with appropriate computer software as computation devices. Due to the large amount of calculations required, multiple computers or processor cores may also be used in parallel. In one embodiment, the computations may be subdivided into a plurality of 2-dimensional geometric regions for one or more computation-intensive steps in the flow, to support parallel processing. In another embodiment, a special-purpose hardware device, either used singly or in multiples, may be used to perform the computations of one or more steps with greater speed than using general-purpose computers or processor cores. In one embodiment, the special-purpose hardware device may be a graphics processing unit (GPU). In another embodiment, the optimization and simulation processes described in this disclosure may include iterative processes of revising and recalculating possible solutions, so as to minimize either the total number of shots, or the total charged particle beam writing time, or the difference between a calculated wafer image and a target wafer image, or MEEF, or CD variation, or some other parameter. In yet another embodiment, the wafer optimization may be performed in a correct-by-construction method, so that no iteration or further simulation are required.

While the specification has been described in detail with respect to specific embodiments, it will be appreciated that those skilled in the art, upon attaining an understanding of the foregoing, may readily conceive of alterations to, variations of, and equivalents to these embodiments. These and other modifications and variations to the present methods for OPC, fracturing, mask data preparation, and wafer optimization may be practiced by those of ordinary skill in the art, without departing from the spirit and scope of the present subject matter, which is more particularly set forth in the appended claims. Furthermore, those of ordinary skill in the art will appreciate that the foregoing description is by way of example only, and is not intended to be limiting. Steps can be added to, taken from or modified from the steps in this specification without deviating from the scope of the invention. In general, any flowcharts presented are only intended to indicate one possible sequence of basic operations to achieve a function, and many variations are possible. Thus, it is intended that the present subject matter covers such modifications and variations as come within the scope of the appended claims and their equivalents.

What is claimed is:

1. A method for optimization of a design comprising an image for a substrate, the substrate to be manufactured using an optical lithographic process with a reticle, the method comprising the steps of:
determining a plurality of variable shaped beam (VSB) shots that are designed to produce a target pattern on the reticle, wherein at least two shots in the plurality of VSB shots overlap;
simulating a reticle pattern that will be produced on the reticle from the plurality of VSB shots;
calculating a substrate image which will be formed on the substrate using the optical lithographic process with the simulated reticle pattern; and
modifying a shot in the plurality of VSB shots to improve the calculated substrate image.

2. The method of claim 1 wherein the step of modifying improves a manufacturability characteristic of the calculated substrate image, wherein the manufacturability characteristic is selected from the group consisting of process variation (PV) band, depth of field, mask edge error factor (MEEF), critical dimension (CD) variation, and area variation.

3. The method of claim 1 wherein in the step of modifying, the improvement comprises reducing the difference between the calculated substrate image and a target substrate image.

4. The method of claim 1 wherein the target reticle pattern has been determined from a target substrate image using optical proximity correction (OPC).

5. The method of claim 4 wherein the OPC comprises inverse lithography technology (ILT).

6. The method of claim 5 wherein the ILT generates only ideal ILT curvilinear shapes.

7. The method of claim 1 wherein the step of modifying comprises the steps of:
simulating a revised reticle pattern that will be produced on the reticle from the modified plurality of VSB shots; and
calculating a revised substrate image that will be formed on the substrate using the optical lithographic process with the simulated revised reticle pattern as a photomask.

8. The method of claim 1 wherein the step of simulating the reticle pattern comprises charged particle beam simulation.

9. The method of claim 8 wherein the charged particle beam simulation includes at least one of a group consisting of forward scattering, backward scattering, resist diffusion, Coulomb effect, fogging, loading and resist charging.

10. The method of claim 1 wherein the step of simulating the reticle pattern comprises simulating at least one of the group consisting of resist bake, resist development and etch.

11. The method of claim 1 wherein the step of calculating the substrate image comprises lithography simulation.

12. The method of claim 1 wherein the step of modifying a shot comprises a shot modification technique selected from the group consisting of changing a shot position, changing a shot size and changing a shot dose.

13. The method of claim 1 wherein the step of modifying a shot comprises using an optimization technique.

14. A method for manufacturing an integrated circuit comprising a target image for a substrate, the substrate to be manufactured using an optical lithographic process with a reticle, the method comprising the steps of:
determining a plurality of variable shaped beam (VSB) shots that are designed to produce a target pattern on the reticle, wherein at least two shots in the plurality of VSB shots overlap;
simulating a reticle pattern that will be produced on the reticle from the plurality of VSB shots;
calculating a substrate image which will be formed on the substrate using the optical lithographic process with the simulated reticle pattern;
modifying a shot in the plurality of VSB shots to improve the calculated substrate image; and
forming a pattern on the reticle with the modified plurality of VSB shots.

15. The method of claim 14 wherein the step of modifying improves a manufacturability characteristic of the calculated substrate image, wherein the manufacturability characteristic is selected from the group consisting of process variation (PV) band, depth of field, mask edge error factor (MEEF), CD variation, and area variation.

16. The method of claim 14 wherein in the step of modifying, the improvement comprises reducing the difference between the calculated substrate image and a target substrate image.

17. The method of claim 14 wherein the target reticle pattern has been determined from the target image for the substrate using optical proximity correction (OPC);

18. The method of claim 17 wherein the OPC comprises inverse lithography technology (ILT).

19. The method of claim 18 wherein the ILT generates only ideal ILT curvilinear shapes.

20. The method of claim 14 wherein the step of modifying comprises the steps of:
simulating a revised reticle pattern that will be produced on the reticle from the modified plurality of VSB shots; and
calculating a revised substrate image that will be formed on the substrate using the optical lithographic process with the simulated revised reticle pattern as a photomask.

21. The method of claim 14 wherein the step of simulating the reticle pattern comprises charged particle beam simulation.

22. A system for optimization of a design comprising an image for a substrate, the substrate to be manufactured using an optical lithographic process with a reticle, the system comprising:
a device capable of determining a plurality of variable shaped beam (VSB) shots from a target reticle pattern, wherein at least two shots in the plurality of VSB shots overlap, and wherein the target reticle pattern has been determined from a target image for the substrate using optical proximity correction (OPC);
a device capable of simulating a reticle pattern that will be produced on the reticle from the plurality of VSB shots;
a device capable of calculating a substrate image which will be formed on the substrate using the optical lithographic process with the simulated reticle pattern; and
a device capable of modifying a shot in the plurality of VSB shots to improve the calculated substrate image.

23. The device of claim 22 wherein the device capable of modifying improves a manufacturability characteristic of the calculated substrate image, wherein the manufacturability characteristic is selected from the group consisting of process variation (PV) band, depth of field, mask edge error factor (MEEF), CD variation, and area variation.

24. The device of claim 22 wherein in the device capable of modifying, the improvement comprises reducing the difference between the calculated substrate image and a target substrate image.

25. The system of claim 22 wherein the device capable of simulating the reticle pattern comprises a device capable of performing charged particle beam simulation.
